(19) United States
(12) Patent Application Publication
(10) Pub. No.: US 2014/0207627 A1
(43) Pub. Date: Jul. 24, 2014

(54) Interface for Price Determination

(71) Applicant: Binyamin-Yefet SONOVANI, Katzrin (IL)

(72) Inventor: Binyamin-Yefet SONOVANI, Katzrin (IL)

(21) Appl. No.: 13/748,661

(22) Filed: Jan. 24, 2013

(51) Int. Cl. G06Q 30/06

(52) U.S. Cl. CPC G06Q 30/0641; G06Q 30/0206
USPC 705/27.1

(57) ABSTRACT

A system and method for determination of a parameter is disclosed, wherein a use controls the position of a mobile element in an animation. For instance, the user may affect the position of an animated element using the mouse, and may start or stop the element using the mouse button. The method may be used for instance to determine a price, volume, or other parameter.

### BACKGROUND

1. Technical Field

Embodiments of the present invention relate generally to interfaces for systems and methods connected with price determination for goods and services.

2. Description of Related Art

Animated elements are generally not responsive to user input, often being fixed loops running independent of user input.

Hence, an improved method for parameter determination using position of animated elements remains a long felt need.

### BRIEF SUMMARY

An aspect of the present invention provides a method for parameter determination comprising steps of:
displaying an animated element responsive to a first user input;
halting said animated element in response to a second user input;
determining the value of a parameter based upon the position of said animated element;
wherein a parameter is determined based upon the position of an animated element which in turn depends upon user input.

It is further within provision of the invention wherein said first user input comprises a pointer position.

It is further within provision of the invention wherein said second user input comprises a button press.

It is further within provision of the invention wherein said animated element and first and second user inputs are implemented using a computer.

It is further within provision of the invention wherein said first user input comprises a mouse position

It is further within provision of the invention wherein said second user input comprises a mouse button press.

It is further within provision of the invention wherein determination of the value of said parameter is based upon the vertical height of said animated element.

It is further within provision of the invention wherein said parameter is used to allow a user to purchase of a discounted goods or services by means of the steps:
determining a market price A for said discounted good;
determining a base sale price B for said discounted good;
determining an actual sale price C for said discounted good by use of price-determining means;
charging said user with any amount C;
crediting said user for any amount C-A>0 towards future purchases;
wherein variable pricing is employed to allow said user to purchase at a discount from said market price and simultaneously allowing a seller to sell at a premium to said market price.

It is further within provision of the invention wherein said price determining means comprises an object having a symbol that can move relative to said object 102, the actual sale price C being determined as a function of the position of said object.

It is further within provision of the invention wherein the position of said object is partially controlled by said user.

It is further within provision of the invention to disclose a non-transitory computer readable storage medium storing one or more programs comprising instructions, which when executed by a computer cause the computer to:
display displaying an animated element responsive to a first user input;
halt said animated element in response to a second user input;
determine the value of a parameter based upon the position of said animated element;
wherein a parameter is determined based upon the position of an animated element which in turn depends upon user input.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates an example object and symbol of the invention in a first relative position; and

FIG. 2 illustrates an example object and symbol of the invention in a first relative position;

FIG. 3 illustrates an example object and symbol of the invention in a first relative position.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing an interface for price determination.

In the following detailed description, numerous specific details are set forth in order to provide a thorough understanding of embodiments of the present invention. However, those skilled in the art will understand that such embodiments may be practiced without these specific details. To justly and entirely describe renditions of each embodiment may not yield full reportage of underlying concepts. Thus we may generally articulate that not all embodiments are necessarily described herein, but that the concepts underlying the invention are fully disclosed.

Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1,5, or 10).

The invention deals with a novel interface for use in conjunction with (for example) methods dealing with sales and associated infrastructure.

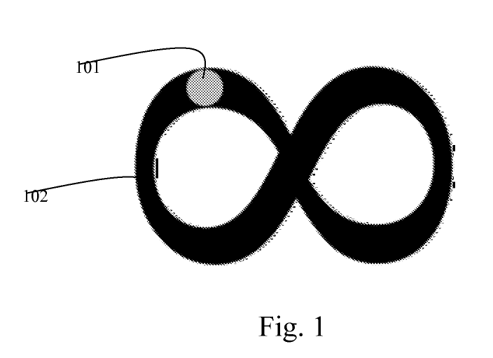

This interface takes the form of an icon or symbol having moving elements or motifs. The price determining mechanism is implemented for example by means of a pictographic representation as shown in FIGS. 1-3.

In these figures a symbol 101 travels within an object 102 which in some embodiments of the invention is a ‘lazy eight’ or infinity symbol.

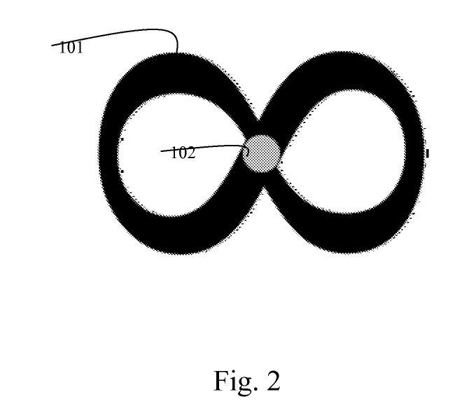

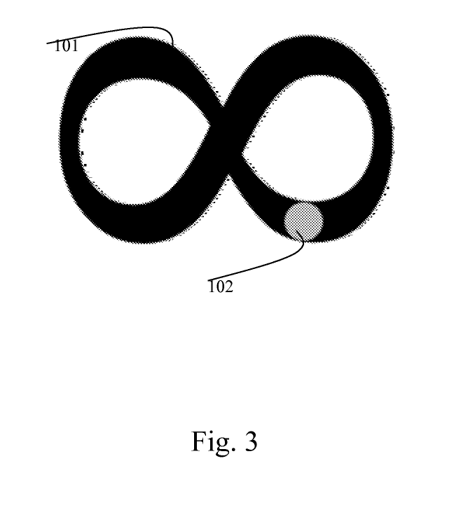

The figure may be used in some embodiments of the invention as a button, for instance a ‘buy’ button on a website. When the customer clicks the button, parameters such as sale price, sale length, random elements or the like may be fixed in accordance with the position of the symbol 101; for instance when the symbol is high the sale price or other parameter is set to be above the actual original price (FIG. 1), while if the symbol is in a middling height the sale price is set to be equal to the actual original price (FIG. 2) while if the symbol is low the sale price is set to be below the actual price (FIG. 3).

Thus in principle the actual sale price changes and is not known aforehand in the sale process.

The movement of the symbol 101 may be at a fixed or variable speed, and as mentioned the price varies depending on where the cursor stops him.

If the cursor stops as in FIG. 1 the sale price may be fixed at the market price or slightly more. If the cursor is in the middle as in FIG. 2 the price is set to be an average sale price, while if the cursor is low as in FIG. 3 the sale price is set to be lower than the market price by some amount. The exact amounts by which the sale price changes, and the relation between sale price and symbol 101 position, are able to vary within ranges or to be set to specific values in accordance with the whim of the system operator.

The cursor can move at different speeds—for example on an uphill rise, the speed may increase more slowly, while on a decline it may move faster. Or, at first the symbol may move faster and subsequently slower, as though affected by time-varying forces or the geometry of the object 102 or by random influences.

For example, the method is able to create a variable and unknown price for purchase or sale, actively or passively, in the form of a game or graphical representation whatsoever.

A system and method for determination of a parameter is disclosed, wherein a use controls the position of a mobile element in an animation. For instance, the user may affect the position of an animated element using the mouse, and may stop the element using the mouse button. The method may be used for instance to determine a price, volume, or other parameter.

The method may also be used in selling medium, such as in a store or in online sales. For instance the height of the animated object may be used to determine a sale price: Online sales often sell at a discount from the market price, for example selling at 80 cents on the dollar, such that an item normally priced at 100$ would sell online for 80$.

The animated method described above could allow for the operator of such an online site to profit as follows. A price is fixed by means of the animated element described above. This price has a floor at 80 cents on the dollar and a ceiling somewhat above this, such as 50% above market price. Thus the sale price of the online good would be between $150 and $80. Any price over the $80 base price is used as credit towards purchasing further goods. Thus the operator benefits from further purchases, while not actually losing any money. Similarly the purchaser benefits from perceived lower prices, while any price higher than the $80 net price is not actually lost since it is made good towards future purchases.

Each sale process produces price changes; each sale process creates customer benefit in money or other value representation.

The method of sale operates according to the following principles:

The sale process client start the sale process (which in certain embodiments is called ‘infinity’) and gets variable prices in accordance with the aforementioned scheme.

If the price is higher than the market price, the client gets a purchase coupon for a further purchase, or alternatively receives a cumulative credit good for future shopping.

Every customer can win, depending on system design. For example, in an embodiment consistent with the invention, 50% of the final price is determined by the symbol 101 position and the remainder is determined by the merchant in the form of a base price.

In one embodiment consistent with the invention, when the symbol 101 moves, the purchaser waits for it to stop. The price determined in stopping the cursor is the price of the product.

As before, the cursor runs at varying and unknown speed.

The customer can redeem the money received (assuming he has bought at a reduced price). The money received may be derived e.g. from the difference between sale price and market price. These redemptions may be saved and accumulated. The customer is notified that he has accrued a given amount of money by means of a bottom line or balance indicator. This credit may be used to buy goods or services immediately, or may be accrued, or alternatively the credit may be sent to a friend or any other user of the inventive method.

A key provision of the invention is for those cases wherein the customer pays more than market price for the good or service rendered. In this case the amount overpaid is used as a credit towards future purchases.

The system may be operated using random stopping times for the symbol 101, the randomization being reset every 10 buyers. It is a principle of the invention that the customer always benefits in some wise monetarily by operation of the system, even in cases where he pays more than market value, by means of credit as explained above.

The base target price is set by the seller in certain embodiments of the invention.

The invention adds to standard buttons, animation in the form of motion added to the standard purchase button.

There may be fixed parameters set, such as that 80% of the time (or any other percentage) the customer receives a better price than the market price. Thus the operator may set for instance that the user may even get a half price discount.

Even if the user receives a higher price, the difference between a base price (which may be the market price, the online price, or some function of these two) will be recorded and added as credit towards future purchases.

In one embodiment of the invention, the customer enters a site employing the inventive method, and chooses a product for sale. This is facilitated by “Buy” or “Add to Cart” buttons on items for sale on the site.

At this point there are two options: a regular checkout, by means for instance of a ‘checkout’ button, or a second option having variable prices as described above. This may in some embodiments be described by the term “SUPRICE”, a combination of “surprise” and “price”.

The client may choose the variable price fund, and sees before him the form of an infinity symbol with marker 101 moving along its curves. The user's cursor can stand and can make movement within the symbol, for example allowing the symbol to be dragged or otherwise influenced by the mouse.

When a customer clicks on “Buy”, the marker 101 runs and stops after a while. The point at which the cursor stops in the object 102 determines the price. For instance, in one embodiment the price is directly related to the height of the cursor.

In the case that the price determined by the above process is below the ‘base’ or average market price, the customer receives a discount in the form of money immediately exercisable, or benefit, or other cash equivalent.

After selecting a good or service for purchase, the customer makes the purchase.

It is within provision of the invention that the mouse position be used to determine animation parameters.

It is within provision of the invention that mouse velocity be used to determine animation parameters.

It is further within provision of the invention that higher derivatives of mouse position with respect to time be used to determine animation parameters. Thus for instance acceleration, jerk and the like may all be utilized to determine parameters of the animation.

It is also within provision of the invention that mouse buttons may be used to determine parameters of the animation, such as starting times, stopping times, and the like.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A method for parameter determination comprising steps of:
displaying an animated element responsive to a first user input;
halting said animated element in response to a second user input;
determining the value of a parameter based upon the position of said animated element;
wherein said parameter is determined based upon the position of said animated element which in turn depends upon user input.

2. The method of claim 1 wherein said first user input comprises a pointer position.

3. The method of claim 1 wherein said second user input comprises a button press.

4. The method of claim 1 wherein said animated element and first and second user inputs are implemented using a computer.

5. The method of claim 4 wherein said first user input comprises a mouse position.

6. The method of claim 4 wherein said second user input comprises a mouse button press.

7. The method of claim 1 wherein determination of the value of said parameter is based upon the vertical height of said animated element.

8. The method of claim 1 wherein said parameter is used to allow a user to purchase of a discounted goods or services by means of the steps:
determining a market price A for said discounted good;
determining a base sale price B for said discounted good;
determining an actual sale price C for said discounted good by use of price-determining means;
charging said user with any amount C;
crediting said user for any amount C-A>0 towards future purchases;
wherein variable pricing is employed to allow said user to purchase at a discount from said market price and simultaneously allowing a seller to sell at a premium to said market price.

9. The method of claim 8 wherein said price determining means comprises an object 102 having a symbol 103 that can move relative to said object 102, the actual sale price C being determined as a function of the position of said object 102.

10. The method of claim 9 wherein the position of said object 101 is partially controlled by said user.

11. A non-transitory computer readable storage medium storing one or more programs comprising instructions, which when executed by a computer cause the computer to:
a. display displaying an animated element responsive to a first user input;
b. halt said animated element in response to a second user input;
c. determine the value of a parameter based upon the position of said animated element;
wherein a parameter is determined based upon the position of an animated element which in turn depends upon user input.

12. The device of claim 11 wherein said first user input comprises a pointer position.

13. The device of claim 11 wherein said second user input comprises a button press.

14. The device of claim 11 wherein said animated element and first and second user inputs are implemented using a computer.

15. The device of claim 14 wherein said first user input comprises a mouse position

16. The device of claim 14 wherein said second user input comprises a mouse button press.

17. The device of claim 11 wherein determination of the value of said parameter is based upon the vertical height of said animated element.

18. The device of claim 11 wherein said parameter is used to allow a user to purchase of a discounted goods or services by means of the steps:
determining a market price A for said discounted good;
determining a base sale price B for said discounted good;
determining an actual sale price C for said discounted good by use of price-determining means;
charging said user for the amount C;
crediting said user for any amount C-A>0, which is then credited towards future purchases;
wherein variable pricing is employed to allow said user to purchase at a discount from said market price and simultaneously allowing a seller to sell at a premium to said market price.

19. The device of claim 18 wherein said price determining means comprises an object 102 having a symbol 103 that can move relative to said object 102, the actual sale price C being determined as a function of the position of said object 102.

20. The device of claim 19 wherein the position of said object 101 is partially controlled by said user.
wherein variable pricing is employed to allow said user to purchase at a discount from said market price and simultaneously allowing a seller to sell at a premium to said market price.
